(19) United States
(12) Patent Application Publication
(10) Pub. No.: US 2007/0110061 A1
(43) Pub. Date: May 17, 2007

(54) Method of scheduling broadcasts in a self-organizing network

(75) Inventors: Rajendra Singh Sisodia, Bhopal (IN); Nitin Koppalkar, Bangalore (IN); Animesh Bhowmick, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,549

(22) PCT Filed: Dec. 13, 2004
(86) PCT No.: PCT/IB04/52792

§ 371 Date: Jun. 16, 2006

(30) Foreign Application Priority Data
Dec. 22, 2003 (EP) 03104890.3

(51) Int. Cl. H04L 12/56

(52) U.S. Cl. 370/390

(57) ABSTRACT

In self-organizing networks, broadcasts comprising presence information, referred to as beacons, are the default mechanism in finding neighboring information, i.e. information on which devices are present in the network of a given device. Such beacons are transmitted periodically from each device. A device has knowledge of the presence of other devices in the network when it receives beacons from them. The method of the invention suggests that a device could skip its subsequent scheduled beacon if all its neighboring devices have received a previous beacon during the same period.

### FIELD OF THE INVENTION

The invention relates to a method of scheduling broadcasts in a self-organizing network, the method comprising the steps of transmitting a broadcast comprising presence information from a first device to its neighboring devices in the self-organizing network every period T_{B}. The invention further relates to a device and a self-organizing network comprising devices.

### BACKGROUND OF THE INVENTION

Self-organizing networks are networks in which a collection of devices, referred to as nodes, with network interfaces may form a temporary network without the aid of any established infrastructure or centralized administration. The topology of the self-organizing network may change rapidly, especially in wireless networks of mobile devices, where the mobile devices are capable of moving. Typically, communication between two wireless nodes is only possible when the two nodes are within radio communication range. Existing examples of such self-organizing networks are Mobile Ad-hoc Networks (MANETs), Multi-hop cellular networks (MCN) or Personal Area Networks (PANs). Self-organizing wireless networks have immediate utility in a variety of industrial, medical, consumer and military applications.

Each node in the network periodically sends out a beacon, i.e. a broadcast comprising presence information. All nodes receiving this beacon consider the sending node as a neighbor and update a table of neighboring nodes. Beacons are the default mechanism in finding neighboring information for self-organizing devices. These beacons are periodic and are required to be transmitted periodically by each device. This helps each device to know the presence of new devices and to assess that current devices are still in its transmission range. However, transmitting these beacons is power and bandwidth-consuming. There is a need for a method of scheduling the beacons in an efficient way and the object of the invention is to provide such a method.

The object is achieved when the method mentioned in the opening paragraph is characterized in that the transmission of a broadcast comprising presence information from the first device is skipped if all its neighbors have received the broadcast from the first device during a period T_{CB}. This provides a way of skipping broadcasts without losing information regarding the neighboring devices of a first device. When broadcasts or beacons can be skipped, the power consumption in the devices and the bandwidth consumption can be reduced. Moreover, collisions between transmitted broadcasts can be reduced by the method of the invention. The self-organizing network may be wired, wireless, or a combination thereof. A device in the network may be mobile or stationary.

Preferably, the first device in the self-organizing network keeps a list of those devices that are its neighboring devices. Thus, the devices in the self-organizing network keep track of their current neighboring devices. The list of neighboring devices is typically used both in checking if new devices have entered the network and if devices have left.

Preferably, the transmission of the broadcast comprising presence information from the first device is skipped during a second part of the period T_{CB} if all its neighbors have received the broadcast from the first device during a first part of period T_{CB}.

In a preferred embodiment, the broadcast comprising presence information transmitted from a device further comprises information on whether the device has received a broadcast from each device in a list of neighboring devices. This provides a way of determining when to skip a broadcast without losing information regarding the presence of neighboring devices. The information on whether the device has received a broadcast from each device in its list of neighboring devices may be in the form of a bit in the broadcast comprising presence information, which bit is set under certain conditions (see, for example, below) and which bit indicates, to the receiving neighboring devices, whether said neighboring devices should skip a broadcast or not.

Preferably, T_{B}<T_{CB}. T_{B} is the beacon period, i.e. the time between broadcasts comprising presence information transmitted from a device in the self-organizing network, and T_{CB} is the check beacon period, i.e. the time between every check for reception of broadcasts from neighboring devices. The beacon period is preferably equal for each device in the network; however, the beacon periods for the different devices are typically not synchronized. The same applies to the check beacon period. It should be noted that the device detects reception of beacons substantially continuously, but the checking of reception of broadcasts from neighboring devices at the check beacon period T_{CB} identifies which devices are currently neighboring devices.

In a further preferred embodiment, T_{CB}=N*T_{B}, where NεN+. When T_{CB}=N*T_{B}, the beacon checking is synchronized with the beacon transmission, which helps to maintain correct neighboring information for protocols that use a two-hop topology. Preferably, N equals 2, 3 or higher numbers.

It is preferred that a broadcast comprising presence information transmitted from the device comprises a skip beacon bit, which is set if both of the following conditions are met:
(t_{CB(i),next}−t)>T_{B};

a broadcast comprising presence information has been received from each device in the list of neighboring devices in the current T_{CB},

where t_{CB(i), next} is the next instant in time, at which the device is arranged to check from which devices it has received broadcasts comprising presence information and t is the current time. This gives a precise indication of the conditions for setting a skip beacon bit, which is a bit indicating to the receiving stations whether they might skip the next broadcast otherwise scheduled.

Preferably, a device will skip a broadcast if both of the following conditions are met:

all broadcasts comprising presence information from devices in the list of neighboring devices in the current period T_{CB} have the skip beacon bit set;
(t_{CB(j),next}−t)>T_{B},
where t_{CB(j), next} is the next instant in time, at which the device is arranged to check from which devices it has received broadcasts comprising presence information and t is the current time.

Together with the above two conditions, these conditions give a precise indication of whether a station can skip a broadcast.

In yet a further preferred embodiment, the broadcast comprising presence information transmitted from a first device further comprises a list of neighboring devices of the first device. This facilitates routing in a two-hop topology. When a device receives a broadcast comprising presence information, it derives the sender as its neighbor and the devices in the list as devices which can be reached through the transmitting device in the two-hop topology. Conditions on when to set a skip beacon bit in the broadcasts and when a device should skip a broadcast similar to the above conditions are drawn up below. The above can be extended to other multi-hop topologies as well.

In yet another preferred embodiment of the method according to the invention, a device will skip a broadcast if (t_{CB}(j), next−t)>T_{B}, and if one of the following conditions is met:

all broadcasts comprising presence information from devices in the list Nⱼ of neighboring devices in the current period T_{CB} have the skip broadcast bit set

OR

all broadcasts comprising presence information received from devices in Mₖ, where Mₖ⊂Nⱼ, during the current check beacon period have the skip broadcast bit set AND the devices in Nⱼ\Mₖ are not in the “LAST_KNOWN_BEACON” field of any of the broadcasts transmitted from the devices in the list Mₖ,

where the “LAST_KNOWN_BEACON” field indicates from which device a broadcast comprising presence information has been received at the earliest instant during the current check beacon period T_{CB}; t_{CB(i), next} is the next instant in time, at which the device i is arranged to check from which devices it has received broadcasts comprising presence information; and t is the current time. Mₖ is a subset of the list Nⱼ of neighboring devices; thus Mₖ is a list of some of the neighboring devices of the device j. Nⱼ\Mₖ is the remainder of Nⱼ, i.e. a list of the devices which are in Nⱼ, but not in Mₖ.

This preferred embodiment provides a further optimization of power and bandwidth consumption in that it provides a way of transmitting fewer less broadcasts comprising presence information, i.e. beacons, without losing information.

It should be noted that the term “beacon” is understood to cover any broadcast indicating the presence of a device, possibly also containing a list of the neighbors of said device. Moreover, it should be noted that the terms skip broadcast bit and skip beacon bit are used synonymously in this specification.

It should furthermore be noted that the devices in the self-organizing network may be similar or different types of devices; the essential feature of the self-organizing network in which the method could be used is that the devices should be able to transmit and receive broadcasts to and from each other. However, the devices in the self-organizing network should preferably be able to exchange other types of information.

### OBJECT AND SUMMARY OF THE INVENTION

The invention will be explained more fully below in connection with a preferred embodiment and with reference to the drawings, in which:

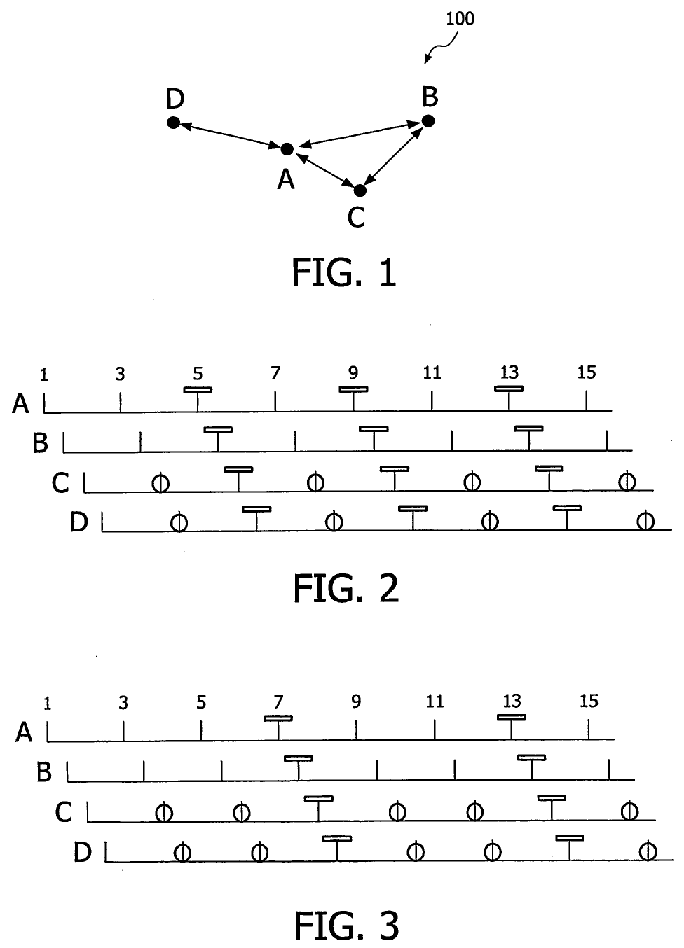

FIG. 1 shows a self-organizing network;

FIGS. 2 to 3 show two examples of the timing of the broadcasts from the nodes in a self-organizing network; and

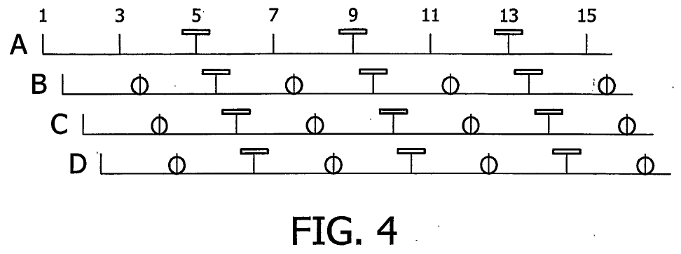

FIG. 4 shows an example of the timing of the broadcasts from the nodes in a self-organizing network, where the broadcasts comprise a list of neighboring mobile devices.

FIG. 1 shows a self-organizing network 100 with four nodes A, B, C and D.

The term “node” is a mobile device (i, j) present in the self-organizing network 100. An arrow between two nodes indicates that said nodes are able to communicate with each other. Typically, this means that said nodes are in radio communication range of each other and capable of exchanging information between each other.

The node A has three neighbors, viz. B, C and D; the nodes B and C have two neighbors each, viz. the node B has the neighbors A and C and the node C has the neighbors A and B. Finally, the node D has only one neighbor, viz. A. This self-organizing network 100 is used as the basis of FIGS. 2 to 4.

FIG. 2 shows an example of the timing of the broadcasts from the nodes in the self-organizing network 100 shown in FIG. 1. The broadcasts comprise presence information and are sent from any node in the self-organizing network 100 to its neighboring mobile devices. Such a broadcast is called a beacon. A beacon is sent from each node, i.e. mobile device, in the network periodically.

The horizontal lines in FIG. 2 indicate the time in seconds corresponding to the numbers at the top of the Figure. The vertical lines indicate instants of transmitting beacons, the vertical lines with rectangles correspond to instants of checking for reception of broadcasts from neighboring nodes and the vertical lines substantially surrounded by circles correspond to instants where a beacon can be skipped according to the method of the invention.

As noted above, the beacon period T_{B} is equal for each mobile device in the network; however, the beacon periods for the different mobile devices are typically not synchronized, so that the instants of transmitting a beacon is different for the different nodes. The same applies to the check beacon period T_{CB}.

The time between broadcasts containing presence information, i.e. the beacon period T_{B}, is the same for each node and equals 2 seconds in FIG. 2. The time between every check for reception of broadcasts from neighboring nodes is the check beacon period T_{CB}, which, in FIG. 2, equals 4 seconds.

The beacon period T_{B} and the check beacon period T_{CB} are synchronized for each node, so that the instants of checking received beacons coincide with instants of transmitting beacons for each node. However, in FIG. 2, nodes A, B, C and D, respectively, start transmitting beacons shifted in time, so that node A starts transmitting beacons at the time 1 second, node B at the time 1.5 second, node C at the time 2 seconds and node D at the time 2.5 seconds.

After beacon transmission by every neighboring node, each node has knowledge of its neighbors, i.e. its neighboring topology. For example, node A knows that it has the three neighbors B, C and D. Nodes B and C know about their two neighbors and node D knows about its neighbor A.

It is assumed that the neighboring topology of the nodes A, B, C and D remains stable for the shown period (1 to 16.5 seconds); this helps to maintain correct neighboring information for use in two-hop topology. In a two-hop topology, each node i keeps an updated list Nᵢ of its neighboring nodes. After beacon checking at the node i, the correct list Nᵢ is known and can be transmitted together with the next scheduled beacon to be used in a two-hop or in other multi-hop topologies.

It will be explained hereinafter when a scheduled beacon can be skipped according to the method of the invention. When a node receives a beacon from all its neighboring nodes long before the time for it to check the received beacons, the node informs its neighbors to skip their scheduled beacons under the condition that they have also received beacons from all of their other neighboring nodes in their current check beacon period. As mentioned above, the mobile device detects reception of beacons substantially continuously, but the checking of reception of broadcasts from neighboring mobile devices at the check beacon period T_{CB} identifies which mobile devices are currently neighboring mobile devices.

If t is the current time for a node i, Nᵢ is the neighbor list of the node i, and t_{CB(i),next} is the next instant in time, at which the node i is arranged to check from which mobile devices it has received broadcasts comprising presence information and T_{B} denotes the beacon period, and the conditions for a node to set a skip beacon bit to be transmitted together with its subsequent beacon are:
(t_{CB(i),next}−t)>T_{B} (1)

a broadcast comprising presence information has been received from each mobile device in the list Nᵢ of neighboring mobile devices in the current T_{CB} (2)

A node j will skip its subsequent beacon transmission if:

all broadcasts comprising presence information from mobile devices in the list Nⱼ of neighboring mobile devices in the current period T_{CB} have the skip beacon bit set (3)
(t_{CB(j),next}−t)>T_{B} (4)
where t is the current time and t_{CB(j),next} is the next instant in time, at which the node j is arranged to check from which mobile devices it has received broadcasts comprising presence information.

The time between two check beacon instants of node A, e.g. the time between 5 and 9 seconds, will now be considered. Shortly after the time 6.5 seconds, node A has received beacons from each neighboring node, so conditions (1) and (2) above are satisfied. Consequently, node A can set the skip beacon bit in its beacon and transmit the beacon together with the skip beacon bit at the time 7 seconds. After a short time span (due to the transmission time between the neighboring nodes) the nodes B, C and D receive the beacon from node A containing a set skip beacon bit. Said nodes will check the conditions (3) and (4) above to check if they can skip their subsequent scheduled beacon. Condition (3) is not satisfied for node B, because it has not received a beacon from node C containing a set skip beacon bit. Both conditions, (3) and (4), are satisfied for the nodes C and D; thus, they will skip their scheduled beacon at the instants 8 seconds and 8.5 seconds, respectively. This is indicated in FIG. 2 as the vertical lines surrounded by circles at the instant 8 seconds on the time line for node C and at the instant 8.5 seconds on the time line for node D. As indicated in FIG. 2, one half of the scheduled beacons of nodes C and D can be skipped. It can be seen in FIG. 2, where T_{CB}=2*T_{B}, that 8/32=25% of the scheduled beacons can be skipped.

FIG. 3 shows an example of the timing of the broadcasts from the nodes in a self-organizing network. As in FIG. 2, the horizontal lines indicate the time in seconds corresponding to the numbers at the top of the Figure. The vertical lines indicate instants of transmitting beacons, the vertical lines with rectangles correspond to instants of checking for reception of broadcasts from neighboring nodes and the vertical lines substantially surrounded by circles correspond to instants where a beacon can be skipped according to the method of the invention.

Again, the time between broadcasts containing presence information, i.e. the beacon period T_{B}, is the same for each node and equals 2 seconds in FIG. 3. The time between every check for reception of broadcasts from neighboring nodes is the check beacon period T_{CB}, which, in FIG. 3, equals 6 seconds.

The conditions (1) to (4) above for setting a skip beacon bit and for skipping a beacon are the same as explained with reference to FIG. 2.

It is clear from FIG. 3 that a larger percentage of beacons can be skipped. This is due to the fact that check beacon period T_{CB} in FIG. 3 equals 3*T_{B}, so that conditions (1) and (4) are more often satisfied as compared to when T_{CB}=2*T_{B}, as in FIG. 2. In FIG. 3, 10/32=31% of the beacons can be skipped as compared to traditional scheduling.

It will be explained hereinafter how the method of the invention works if a new node joins the self-organizing network and if a current node moves away from the self-organizing network.

Let it be assumed that a new node E has joined the self-organizing network and is only a neighbor of nodes A and C. Node A has knowledge of new nodes in the network only when it checks the beacons received at the check beacon instants. Consequently, the node A will set the skip beacon bit in a beacon, as described above, only when it has received a beacon from all its neighbors in the current check beacon period (conditions (1) and (2)).

If the node C is about to skip the next scheduled beacon (conditions (3) and (4) are satisfied), but receives a beacon from the newly joined node E, the node C cannot skip the next scheduled beacon because the beacon received from node E does not have a skip beacon bit set (condition (3)); in this case, condition (3) ensures that the node C indicates its presence to the new neighboring node E.

Let it be assumed that the self-organizing network consists of the nodes A, B, C and D shown in FIG. 1 and that the node C is leaving the network.

The condition (2) for skipping beacons from the remaining nodes in the network is that a beacon should be received from each node in the list Nᵢ. Two situations may occur: (a) the node C leaves the network without sending a beacon in the current cycle (T_{CB)}) of the nodes A and B, and (b) the node C leaves immediately subsequent to sending a beacon in the current cycle (T_{CB)}) of the nodes A and B.

In situation (a), the nodes A and B are unable to set the skip beacon bit because they have not received the beacon from each of their neighbors (i.e. condition (2) is not satisfied). Therefore, the nodes receiving beacons from nodes A and B cannot skip their subsequent beacons because condition (3) is not satisfied.

In situation (b), the nodes A and B have received a beacon from the node C, and if they receive beacons from other neighbors too, they set the skip beacon bit in their next beacon. The only way a node has knowledge of a node movement is after the current check beacon period, in that it has already received the beacon during the current check beacon period.

FIG. 4 shows an example of the timing of the broadcasts from the nodes in a self-organizing network, where the broadcasts comprises a list of neighboring mobile devices. Similarly as in FIGS. 2 and 3, the horizontal lines indicate the time in seconds corresponding to the numbers at the top of the Figure. The vertical lines indicate instants of transmitting beacons, the vertical lines with rectangles correspond to instants of checking for reception of broadcasts from neighboring nodes and the vertical lines substantially surrounded by circles correspond to instants when a beacon can be skipped according to the method of the invention.

Again, the time between broadcasts containing presence information, i.e. the beacon period T_{B}, is the same for each node and equals 2 seconds in FIG. 4. The time between every check for reception of broadcasts from neighboring nodes is the check beacon period T_{CB}, which, in FIG. 4, equals 4 seconds.

FIG. 4 illustrates the skip beacon mechanism for nodes in a two-hop topology. In FIGS. 2 and 3, each beacon contains the sender address of the node transmitting the beacon; in FIG. 4, each beacon also contains the list Nᵢ of neighboring nodes of the node i. Furthermore, each beacon contains a field “LAST_KNOWN_BEACON” indicating which node has sent a beacon at the earliest instant during the current check beacon period. In other words, the field “LAST_KNOWN_BEACON” indicates from which node a beacon has been received at the earliest instant during the current check beacon period T_{CB}.

At the instant 7 seconds, the field “LAST_KNOWN_BEACON” of the node A equals “B”, since B is the first node having transmitted a beacon to A (at the instant 5.5 seconds). Similarly, for node B. “LAST_KNOWN_BEACON” equals “C”, etc.

When node A transmits a beacon at the instant 7 seconds, it has the skip beacon bit set (as explained above). The nodes C and D skip their subsequent beacons for the reasons explained with reference to FIG. 2. Moreover, the node B skips its subsequent scheduled beacon (scheduled at the instant 9.5 seconds) with the help of the field “LAST_KNOWN_BEACON” and with two-hop topology.

For example, the beacon sent from node A at the instant 7 seconds contains the list N_{A} of the neighboring nodes of node A together with the field “LAST_KNOWN_BEACON”. The list N_{A} contains the nodes B, C and D, and the field “LAST_KNOWN_BEACON” equals “B”. With this information, the node B can derive that the nodes C and D can be reached through the node A and that each of them has transmitted a beacon to node A after the preceding transmission of the beacon at the instant 5.5 seconds.

The condition (3) above can thereby be changed to the following:

all broadcasts comprising presence information from mobile devices in the list Nⱼ of neighboring mobile devices in the current period T_{CB} have the skip beacon bit set (3a)

OR

all beacons comprising presence information received from mobile devices in Mₖ, where Mₖ⊂Nⱼ, during the current check beacon period have the skip beacon bit set AND the mobile devices in Nⱼ\Mₖ is not in the “LAST_KNOWN_BEACON” field of any of the beacons transmitted from the mobile devices in the list Mₖ. (3b)

where Mₖ is a subset of the list Nⱼ of neighboring nodes; thus Mₖ is a list of some of the neighboring nodes of the node j. Nⱼ\Mₖ is the remainder of Nⱼ, i.e. a list of the nodes which are in Nⱼ, but not in Mₖ.

Conditions (1), (2), and (4) are kept unchanged. It can be seen that condition (3a) equals the former condition (3), so that alternative condition (3b), i.e. the inclusion of the field “LAST_KNOWN_BEACON”, can be used to skip additional beacons.

In FIG. 4, i.e. when the check beacon period T_{CB} equals 2*T_{B} and when the beacons contain a list of neighboring nodes, 12/32=37.5% of the scheduled beacons can be skipped.

For the sake of clarity, all Figures relate to a self-organizing network comprising only four nodes. However, the conclusions described above can be extended to networks comprising larger numbers of nodes. Thus, in general, the percentage of beacons which can be skipped is increased as T_{CB} is increased in relation to T_{B}.

It has been explained hereinbefore how the method of the invention works if a new node joins the self-organizing network and if a current node moves away from the self-organizing network without the use of the neighboring lists. The method can be arranged to check the neighboring list at each node after every received beacon, which may give rise to the knowledge of a new node entering the network or a current node leaving the network in the current beacon period instead of during the next beacon period. However, this typically causes the processing power in the nodes to increase substantially if there is a large number of neighbors.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention can be implemented by means of hardware comprising several distinct elements, and by means of a suitably programmed computer. ‘Computer program’ is to be understood to mean any software product stored on a computer-readable medium, such as a floppy disk, downloadable via a network, such as the Internet, or marketable in any other manner.

1. A method of scheduling broadcasts in a self-organizing network (100), the method comprising the steps of:
transmitting a broadcast comprising presence information from a first device to its neighboring devices in the self-organizing network every period T_{B},
characterized in that the transmission of a broadcast comprising presence information from the first device is skipped if all its neighbors have received the broadcast from the first device during a period T_{CB}.

2. A method as claimed in claim 1, characterized in that the transmission of the broadcast comprising presence information from the first device is skipped during a second part of the period T_{CB} if all its neighbors have received the broadcast from the first device during a first part of period T_{CB}.

3. A method as claimed in claim 1, characterized in that a broadcast comprising presence information transmitted from a device further comprises information on whether the device has received a broadcast from each device in a list of neighboring devices.

4. A method as claimed in claim 3, characterized in that the broadcast transmitted from the device comprises a skip broadcast bit, which is set if a broadcast comprising presence information has been received from each device in the list of neighboring devices in the current T_{CB}.

5. A method as claimed in claim 4, characterized in that the broadcast transmitted from the device comprises a skip broadcast bit, which is set if both of the following conditions are met:
(t_{CB(i),next}−t)>T_{B};
a broadcast comprising presence information has been received from each device in the list of neighboring devices in the current T_{CB},
where t_{CB(i), next} is the next instant in time, at which the device is arranged to check from which devices it has received broadcasts comprising presence information and t is the current time.

6. A method as claimed in claim 4, characterized in that the device will skip a broadcast if all broadcasts comprising presence information from devices in the list of neighboring devices in the current period T_{CB} have the skip broadcast bit set.

7. A method as claimed in claim 6, characterized in that the device will skip a broadcast if both of the following conditions are met:
all broadcasts comprising presence information from devices in the list of neighboring devices in the current period T_{CB} have the skip broadcast bit set;
(t_{CB(j),next}−t)>T_{B},
where t_{CB(j), next} is the next instant in time, at which the device is arranged to check from which devices it has received broadcasts comprising presence information and t is the current time.

8. A method as claimed in claim 4, characterized in that a device will skip a broadcast if (t_{CB(j), next}−t)>T_{B}, and if one of the following conditions is met:
all broadcasts comprising presence information from devices in the list Nⱼ of neighboring devices in the current period T_{CB} have the skip broadcast bit set
OR
all broadcasts comprising presence information received from devices in Mₖ,
where Mₖ⊂Nⱼ, during the current check beacon period have the skip broadcast bit set AND the devices in Nⱼ\Mₖ are not in the “LAST_KNOWN_BEACON” field of any of the broadcasts transmitted from the devices in the list Mₖ,
where the “LAST_KNOWN_BEACON” field indicates from which device a broadcast comprising presence information has been received at the earliest instant during the current check beacon period T_{CB}; t_{CB(i), next} is the next instant in time, at which the device is arranged to check from which devices it has received broadcasts comprising presence information; and t is the current time.

9. A method as claimed in claim 1, characterized in that T_{B}<T_{CB}.

10. A method as claimed in claim 9, characterized in that T_{CB}=N*T_{B}, where NεN+.

11. A device performing the method as claimed in claim 1.

12. A self-organizing network comprising devices performing the method as claimed in claim 1.

13. A computer program product comprising a program of computer instructions for making a programmable computer perform the method as claimed in claim 1.
